(19) United States
(12) Patent Application Publication
(10) Pub. No.: US 2022/0178771 A1
(43) Pub. Date: Jun. 9, 2022

(54) A PRESSURE SENSOR INCORPORATED INTO A RESILIENTLY DEFORMABLE THERMOPLASTIC POLYMER

(71) Applicant: TECH 21 LICENSING LIMITED, Middlesex (GB)

(72) Inventors: Haim GEVA, Middlesex (GB); Amirah HAKIMAH BINTI ABD AZIZ AL RAHMAN, Middlesex (GB)

(21) Appl. No.: 17/601,279

(22) PCT Filed: Apr. 2, 2020
(86) PCT No.: PCT/GB2020/050878

§ 371 Date: Oct. 4, 2021

(30) Foreign Application Priority Data
Apr. 4, 2019 (GB) 1904768.7

(51) Int. Cl. G01L 1/14; G01L 1/20

(52) U.S. Cl. CPC G01L 1/146; G01L 1/205

(57) ABSTRACT

A resiliently deformable thermoplastic polymer incorporating a pressure sensor. The thermoplastic polymer comprises a non-conductive main portion 1 formed of a resiliently deformable thermoplastic polymer and a pair of compressible electrical elements 2,3 embedded in the main portion 1 and each formed of a flexible thermoplastic polymer as a matrix incorporating a plurality of conductive particle impregnated into the matrix. A (preferably sealed) void 6 is formed between the two electrical elements 2,3. A pressure applied on the sensor causes the deformation of the main portion 1 and of the electrical elements 2,3 causing a change in the spatial relationship of the electrical elements which produces a measurable change in the electrical property proportional to the applied pressure.

The present invention relates to a pressure sensor incorporated into a resiliently deformable thermoplastic polymer.

Such pressure sensors are known in the art in fields which require a pressure measurement within in a flexible thermoplastic polymer. For example, such polymers can be used as a lining in an impact resistant garments such as a helmet, back protectors (e.g. for motorcycling) or contact sports body armour or gloves.

Such pressure sensors are typically formed of a pair of rigid electrical elements which face one another across an air gap. The air gap requires a vent such that, as pressure is applied to the sensor, the rigid plates approach one another thereby displacing the air from the air gap. When the pressure is removed, the air returns to the air gap thereby providing a pressure increase to separate the electrical elements and return them to their rest position.

The displacement of air causes complications in that there must be an air-line leading from each sensor either to a reservoir of air to which the air from the sensor can be temporarily displaced, or, more commonly, to a vent. The use of a reservoir produces a sealed system, but increases the size of the overall system and space must be found for the reservoir. On the other hand, a vented system means that the air paths are open which can allow dirt and moisture into the system or can cause the air flow paths to be blocked or cause corrosion.

As a result of this, the prior art sensors of this type are difficult to implement in practice given their complexity and are therefore expensive and unreliable.

The present invention aims to provide a pressure sensor which addresses one or more of these problems.

According to the present invention there is provided a pressure sensor according to claim 1.

Because the present invention uses compressible electrical elements, the restorative force for the electrical elements upon removal of the load from the sensor can be provided by the resilience of the electrical elements themselves. As a result of this, the void between the electrical elements can be sealed thereby eliminating the need for the air-lines of the prior art. This significantly reduces the complexity of the sensor arrangement as there is no need to accommodate a vent or reservoir with the associated complications as set out above.

Although the use of the compressible elements means that venting to the void is not necessary, the sensor would still work with a vented void and this may be used in some circumstances. However, preferably the void is sealed.

Further, because the main portion and electrical elements are both formed of a resiliently deformable thermoplastic polymer, the sensor can be formed integrally with the surrounding polymer which, in practice, means that it can be formed as part of the manufacturing process of the article being produced. In the prior art, the sensors are made as separate subassemblies which are then attached to the article after this has been formed. The pressure sensor is particularly suited to a 3D printing technique which allows an article to be printed from a combination of a flexible thermoplastic plastic polymer and a flexible thermoplastic plastic polymer comprising the conductive particles.

The sensor may be a resistive sensor, in which case the compressible electrical elements are conductive elements arranged such that a pressure on the sensor causes contact between the conductive elements, with the size of the contact area being proportional to the applied pressure, producing a measurable drop in the resistance across the conductive elements.

Alternatively, the sensor is a capacitive sensor, and the compressible electrical elements are capacitive plates arranged such that a pressure on the sensor causes the plates to be compressed and to approach one another to produce a measurable increase in capacitance.

The resiliently deformable thermoplastic polymer forming the main portion may be different from the flexible thermoplastic polymer forming the electrical elements. However, preferably, the flexible thermoplastic polymers are the same in each case to avoid incompatibility between the materials.

To further enhance the ease of manufacture, preferably electrical connectors to the electrical elements are formed of a flexible thermoplastic polymer as a matrix incorporating a plurality of conductive particles. This allows the electrical connections also to be integrated into the manufacturing process in the same way as the electrical elements. Again, this technique can be readily achieved by 3D printing.

The resiliently deformable thermoplastic polymer may, for example, be a TPU, TPE or TPV. The conductive particles may be any suitably electrically conductive particles which are compatible with the polymer. However, preferably, the particles are carbon black particles, or, more preferably, carbon nanotubes.

The present invention also extends to a method of forming a pressure sensor according to a first aspect to the present invention using 3D printing. The sensor is preferably 3D printed in its final form. In other words, no further processing operations such as folding the 3D printed part are required.

Examples of the polymer incorporating the sensor will now be described with reference to the accompanying drawings, in which:

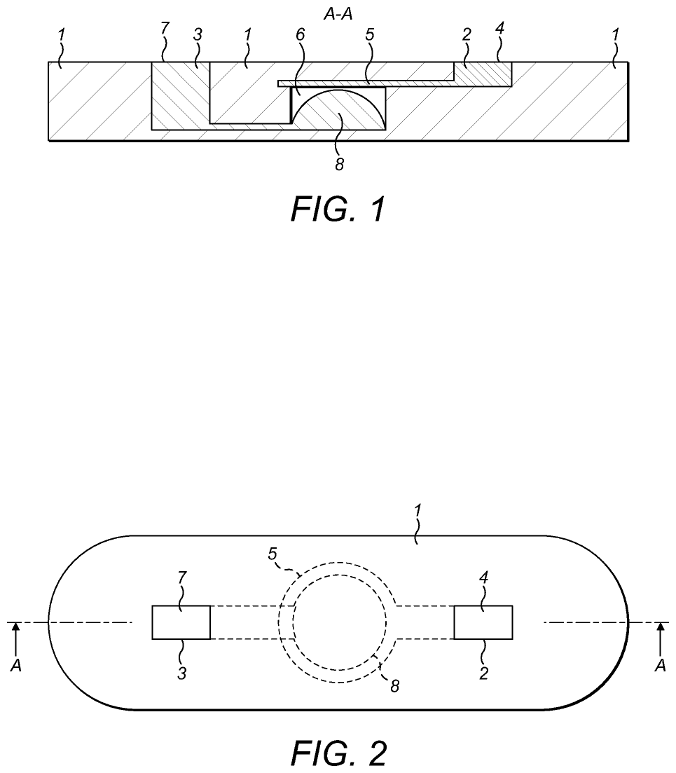

FIG. 1 is a cross section of a first example;

FIG. 2 is a plan view of the first example;

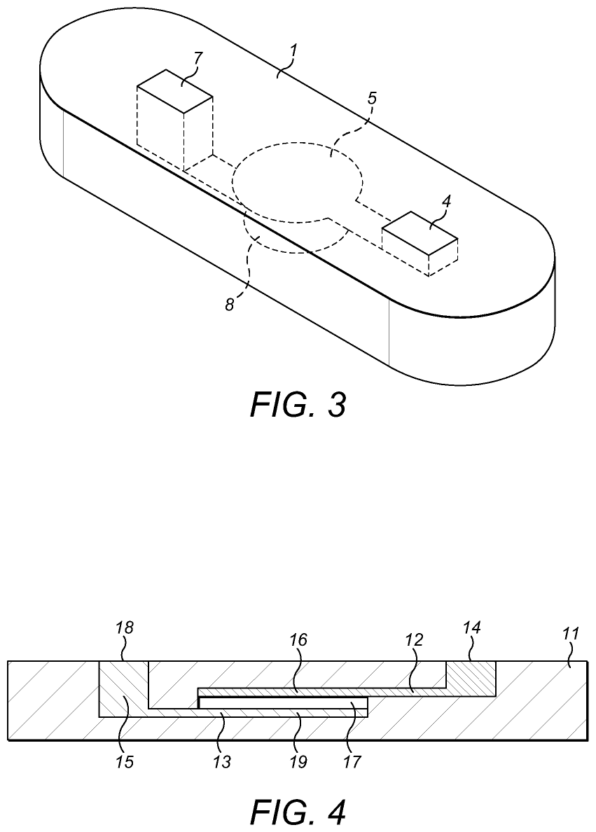

FIG. 3 is a schematic perspective view of the first example; and

FIG. 4 is a cross-sectional view similar to FIG. 1 of a second example.

The first example incorporates a resistive sensor. The majority of the sensor is formed of a resiliently deformable non-conductive polymer 1. Impregnated in this are a pair of conductive elements in the form of an upper element 2 and a lower element 3. The conductive elements 2, 3 are formed of a resiliently deformable thermoplastic polymer which is conveniently the same as the polymer 1. This is impregnated with electrically conductive particles such as carbon black or carbon nanotube particles. The components may be made separately and assembled as shown. However, preferably, it is most convenient to form the arrangement shown in FIG. 1 using a 3D printing technique.

The upper element has a contact 4 which is exposed at the surface of the polymer 1 and a conductive plate 5 which extend from the contact 4 within the polymer above a gap 6. FIG. 1 shows the sensor in the unstressed state, and the gap 6 is shown in this uncompressed state

The lower element 3 has a contact 7 and a lower conductor plate 8 which extends from the contact 7 beneath the air gap 6 so as to face the upper conductor plate 5. As can be seen in FIG. 1, the lower conductor plate has a convex surface, the uppermost portion of which is very close to the upper conductor plate 5.

A pressure force on the top or the bottom of the sensor will cause all of the materials 1, 2 and 3 to deform. This will cause the conductor plates 5, 8 to contact one another and compress any air in the air gap 6. The greater the pressure force on the sensor, the greater the deformity and the greater the contact area between the two plates 5, 8. Thus, the resistance across the conductor plates 5, 8 will decrease in an amount inversely proportional to the applied load. This decrease in resistance can be measured across the contacts 4, 7.

As described above, the air gap 6 can be sealed as there is no need for it to vent. However, a vent can be present if necessary. In any event, once the load is removed, the resilience of the materials 1, 3 and 4 causes the sensor to return to the at rest position as shown in FIG. 1.

A capacitive sensor is shown in FIG. 4. This is formed in the same way as the first example preferably using a 3D printing technique. Again, a non-conductive polymer 11 is provided with a pair of conductive elements in the form of an upper conductive element 12 and a lower conductive element 13. These are provided with contacts 14 and 15 exposed at the top of the conductive polymer 11. The upper conductive element 12 has an upper capacitive plate 16 above an air gap 17. The lower conductive element 13 has a contact 18 and a lower capacitive plate 19.

The pressure on the sensor causes compression of all of the materials 11, 12 and 13 causing the upper 15 and lower 16 capacitive plates to approach one another such that the capacitance increases with increased pressure. This is measured at the contact point.

A polymer can be formed, as shown, as standalone sensor which can be applied to a separate article. However, in the alternative the resiliently deformable polymer 1, 11 may be a part of a larger article so that is fully integrated in that article.

1. A resiliently deformable thermoplastic polymer incorporating a pressure sensor, the resiliently deformable thermoplastic polymer comprising a non-conductive main portion formed of a resiliently deformable thermoplastic polymer and a pair of compressible electrical elements embedded in the main portion and each formed of a flexible thermoplastic polymer as a matrix incorporating a plurality of conductive particle impregnated into the matrix;
further comprising a void between the two electrical elements; and a means for measuring a change of an electrical property between the electrical elements:
wherein a pressure applied on the sensor causes the deformation of the main portion and of the electrical elements causing a change in the spatial relationship of the electrical elements which produces a measurable change in the electrical property proportional to the applied pressure.

2. A resiliently deformable thermoplastic polymer according to claim 1, wherein the void is sealed.

3. A resiliently deformable thermoplastic polymer according to claim 1, wherein the sensor is a resistive sensor, and the compressible electrical elements are conductive elements arranged such that a pressure on the sensor causes contact between the conductive elements, with the size of the contact area being proportional to the applied pressure, producing a measurable drop in the resistance across the conductive elements.

4. A resiliently deformable thermoplastic polymer according to claim 1, wherein the sensor is a capacitive sensor, and the compressible electrical elements are capacitive plates arranged such that a pressure on the sensor causes the plates to be compressed and to approach one another to produce a measurable increase in capacitance.

5. A resiliently deformable thermoplastic polymer according to claim 1, wherein the resiliently deformable thermoplastic polymer forming the main portion is the same as the flexible thermoplastic polymer forming the electrical elements.

6. A resiliently deformable thermoplastic polymer according to claim 1 wherein electrical connectors to the electrical elements are formed of a resilient deformable thermoplastic polymer as a matrix incorporating a plurality of conductive particles.

7. A resiliently deformable thermoplastic polymer according to claim 1 wherein the conductive particles are carbon nanotubes.

8. A method of forming a pressure sensor according to claim 1 using 3D printing.

9. A method according to claim 8, wherein the sensor is 3D printed in its final form.
